(19) United States
(12) Patent Application Publication
(10) Pub. No.: US 2024/0378902 A1
(43) Pub. Date: Nov. 14, 2024

(54) METHOD FOR IDENTIFYING A SEAT OCCUPANCY IN A VEHICLE

(71) Applicant: Robert Bosch GmbH, Stuttgart (DE)

(72) Inventors: Masato Takami, Hildesheim (DE); Fabian Brickwedde, Braunschweig (DE); Uwe Brosch, Algermissen (DE)

(21) Appl. No.: 18/632,759

(22) Filed: Apr. 11, 2024

(30) Foreign Application Priority Data
May 8, 2023 (DE) 10 2023 204 206.1

(51) Int. Cl. G06V 20/59; G06V 10/26; G06V 10/75; G06V 10/82; G06V 40/10

(52) U.S. Cl. CPC G06V 20/593; G06V 10/26; G06V 10/751; G06V 10/82; G06V 40/10

(57) ABSTRACT

A method for identifying a seat occupancy in a vehicle. The method includes: receiving monitoring data of a camera of a vehicle interior; assigning pixels of the monitoring data to components of the vehicle by semantic segmentation using a first neural network; recognizing one or more persons in the monitoring data using a second neural network for recognizing a pose of a person; merging the assigned pixels to the components of the vehicle with the recognized one or more persons, for identifying a seat occupancy in the vehicle.

### CROSS REFERENCE

The present application claims the benefit under 35 U.S.C. § 119 of German Patent Application No. 10 2023 204 206.1 filed on May 8, 2023, which is expressly incorporated herein by reference in its entirety.

### FIELD

European Patent Application No. EP 1 746 527 B1 describes an occupant formation and detection system, an occupant restraint system, and a vehicle.

### SUMMARY

The present invention provides a method for identifying a seat occupancy in a vehicle. According to an example embodiment of the present invention, the method includes the steps of: receiving monitoring data of a camera of a vehicle interior, assigning pixels of the monitoring data to components of the vehicle by semantic segmentation by means of a first neural network;

recognizing one or more persons in the monitoring data by means of a second neural network for recognizing a pose of a person; merging the assigned pixels to the components of the vehicle with the recognized one or more persons, for identifying a seat occupancy in the vehicle.

An advantage of the present invention is that an occupancy of the vehicle seats can in particular be identified safely and/or reliably. Merging may, for example, take place or be designed as a superposition of the recognized components and persons. A seat occupancy in the vehicle can thereby be recognized. In other words, it can be recognized whether persons are located in the vehicle and, if persons in the vehicle have been recognized, where they are located or sitting. The safety in the vehicle can thereby be increased since safety functions can, for example, be triggered specifically. Furthermore, comfort can be increased since comfort features can, for example, be adapted to persons in the vehicle.

Advantageously, this method can be used in any vehicle in which a number of persons and/or a seat assignment is to be identified. Advantageously, a seat assignment can be made possible by means of the proposed method by using the different steps of the assignments of the components and of the person recognition by means of a respective neural network, in particular without calibration for any vehicle type or camera mounting position. This can, for example, be used for a seatbelt alert or statistics on seat occupancies or further surveys in transportation services. Furthermore, by means of the method, it can in particular be recognized if a person moves away from their seat during a trip. To some devices in a vehicle, it may also be relevant whether or not a person is in the driver seat and the car thus has a driver, for example in the case of a manual takeover. This can in particular increase the safety in the vehicle, thus in particular in traffic.

In one exemplary embodiment of the present invention, in the step of recognizing one or more persons in the monitoring data, a two-dimensional pose of a person or a three-dimensional pose of a person can be recognized. In particular, a pose of a person and thus the presence of a person in the vehicle can thereby be ascertained safely and/or reliably.

Advantageously, according to an example embodiment of the present invention, in the step of recognizing one or more persons in the monitoring data, a size of the one or more persons can be recognized. In particular, the distance at which the person is to a camera can thereby be recognized. As a result, it can, for example, be identified whether the person is sitting in the front seats or the rear seats.

In a development of the present invention, in the step of recognizing one or more persons in the monitoring data, articulation points of the one or more persons can be recognized. In particular, a pose of the one or more persons can thereby be recognized safely and/or reliably, whereby a presence of a person in the vehicle can in particular be ascertained safely and/or reliably.

In an advantageous configuration of the present invention, the second neural network for recognizing a pose of a person can be designed as a trained neural network. Alternatively or additionally, the first neural network for semantic segmentation can be designed as a trained neural network. As a result, the method can in particular be designed to be robust, whereby a person in the vehicle can in particular be recognized safely and/or reliably and/or the pixels can be assigned to a component in the vehicle.

Preferably, according to an example embodiment of the present invention, in the step of assigning pixels, a pixel-precise assignment of the monitoring data to components of the vehicle can take place per frame. As a result, a safe and/or reliable assignment of the pixels to the components of the vehicle can be made possible.

In one exemplary embodiment of the present invention, in the step of assigning pixels, pixels can be assigned to one or more components of the vehicle which are arranged in front of a person, wherein, in the step of merging, it is recognized that the person is arranged behind the one or more components of the vehicle. Alternatively or additionally, in the step of assigning pixels, pixels can be assigned to a door of the vehicle which is arranged in front of a person, wherein, in the step of merging, it is recognized that the person is arranged behind the door outside the vehicle. Alternatively or additionally, in the step of assigning pixels, pixels can be assigned to a vehicle seat which is arranged behind a person, wherein, in the step of merging, it is recognized that the vehicle seat is arranged behind the person and the person is arranged in the vehicle seat. In particular, it can thereby, in particular, be safely and/or reliably identified whether persons are arranged or located in front of or behind a component and/or inside or outside a vehicle.

In a development of the present invention, in the step of assigning pixels, the pixels can be assigned to a vehicle seat pixel class, for recognizing which vehicle seat the pixels are assigned to. In particular, it can thereby be safely and/or reliably recognized on which vehicle seat, for example on the driver seat, on the front passenger seat, or on the rear seat bench, a person is arranged or sitting.

Also provided according to an example embodiment of the present invention is a system for identifying a seat occupancy in a vehicle, wherein the system is designed to perform a method for identifying a seat occupancy in a vehicle.

In an advantageous configuration of the present invention, the system comprises a camera for recording monitoring data of a vehicle interior. In particular, the provision of monitoring data of a vehicle interior can thereby be safely and/or reliably ensured.

Furthermore provided according to the present invention are methods for training a first neural network to assign pixels of the monitoring data to components of the vehicle by semantic segmentation for use in a method for identifying a seat occupancy in a vehicle, comprising the steps of:
receiving monitoring data of a camera of a vehicle interior;

learning, for each pixel in a frame, to which component of the vehicle the pixel is assigned.

The pixels can in particular be safely and/or reliability assigned to a component in the vehicle by a trained neural network.

Also provided according to an example embodiment of the present invention is a method for training a second neural network to recognize a pose of a person for use in a method for identifying a seat occupancy in a vehicle, comprising the steps of:
receiving monitoring data of a camera;
learning poses of a plurality of persons.

A person can in particular be safely and/or reliably recognized in the vehicle by a trained neural network.

### BRIEF DESCRIPTION OF THE DRAWINGS

Exemplary embodiments of the present invention are shown in the drawings and explained in more detail in the following descriptions. The same reference signs are used for elements that are shown in the various figures and have a similar effect, wherein a repeated description of the elements is dispensed with.

FIG. 1 shows a schematic representation of a vehicle comprising a device for observing a vehicle occupant, according to an example embodiment of the present invention.

FIG. 2 shows a schematic representation of a method according to an exemplary embodiment of the present invention.

FIG. 3 shows a schematic representation of a method according to an exemplary embodiment of the present invention.

FIG. 4 shows a schematic representation of a method according to an exemplary embodiment of the present invention.

FIG. 5 shows a schematic representation of a system according to an exemplary embodiment of the present invention.

FIG. 6 shows a schematic representation of a vehicle interior according to an exemplary embodiment of the present invention.

FIG. 7 shows a schematic representation of a vehicle interior according to an exemplary embodiment of the present invention.

FIG. 8 shows a schematic representation of a method for identifying a seat occupancy in a vehicle according to an exemplary embodiment of the present invention.

### DETAILED DESCRIPTION OF EXAMPLE EMBODIMENTS

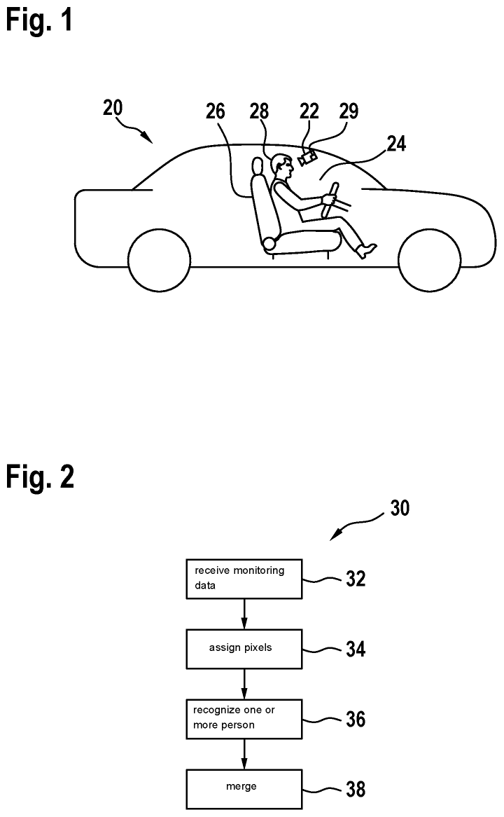

FIG. 1 shows a schematic representation of a vehicle 20, for example a motor vehicle, for example a passenger car, with an observation device 22. The vehicle 20 in particular comprises an interior 24 or a vehicle interior 24, wherein one or more seats 26 for one or more vehicle occupants 28 can in particular be arranged in the vehicle interior 24. The vehicle 20 also comprises an observation device 22 for observing the vehicle interior 24 and/or one or more vehicle occupants 28, for example a driver and/or a front-seat passenger and/or one or more other passengers. The observation device 22 can also be referred to as an observation system, a driver monitoring system, an occupant observation system and/or a monitoring system. The observation device 22 can, for example, be designed to detect a gaze direction, a body posture and/or the position of the head or of the face or of the eyes of the vehicle occupant 28, or the state of tiredness and/or other vital signs of the vehicle occupant 28. Furthermore, it is, for example, possible to detect an identity of the vehicle occupant 28.

The observation device 22 can in particular be arranged in or on a dashboard, in or on an instrument panel, in or on a steering wheel, in or on a vehicle roof, on a windshield, in or on a rear-view mirror, or in or on a pillar, for example on an A- pillar and/or a B-pillar of the vehicle 20, or at another location in the vehicle 20.

For observing the vehicle occupant 28, the observation device 22 can comprise a recording unit or be designed as a recording unit. Advantageously, the observation device 22 can comprise a camera or be designed as a camera. The camera can in particular be directed toward the vehicle interior 24.

In a development, the observation device 22 can comprise an illumination unit for emitting light beams, in particular infrared beams. For example, the illumination unit can be directed toward the vehicle interior 24 in order to illuminate it with light beams, for example, with infrared beams. The illumination unit can, for example, be designed as a light unit, light element, light diode, LED, OLED and/or laser diode and/or comprise a light unit, a light element, a light diode, an LED, OLED and/or a laser diode. The light beams emitted by the illumination unit can preferably be reflectable on or in the vehicle interior, wherein the reflected light beams are directable toward the recording unit. Alternatively, the observation device 22 can comprise no separate illumination unit and the vehicle interior or the vehicle occupants are illuminated by light from an environment.

The recording unit can, for example, be designed as an image recording unit, for example as an optical sensor or as a camera, in particular as an infrared camera module, wherein the recording unit is directed toward the vehicle interior 24 in order to visually detect it. The design as an infrared camera module makes it possible to carry out the observation even at night, without brightly illuminating, and thereby bothering or blinding, the vehicle occupant 28.

The observation device 22 also comprises a control unit 29 or an evaluation unit 29 or a computing unit 29, for controlling the illumination unit and/or the recording unit and/or for processing the data recorded by means of the recording unit. The control unit 29 can in particular be part of the observation device 22.

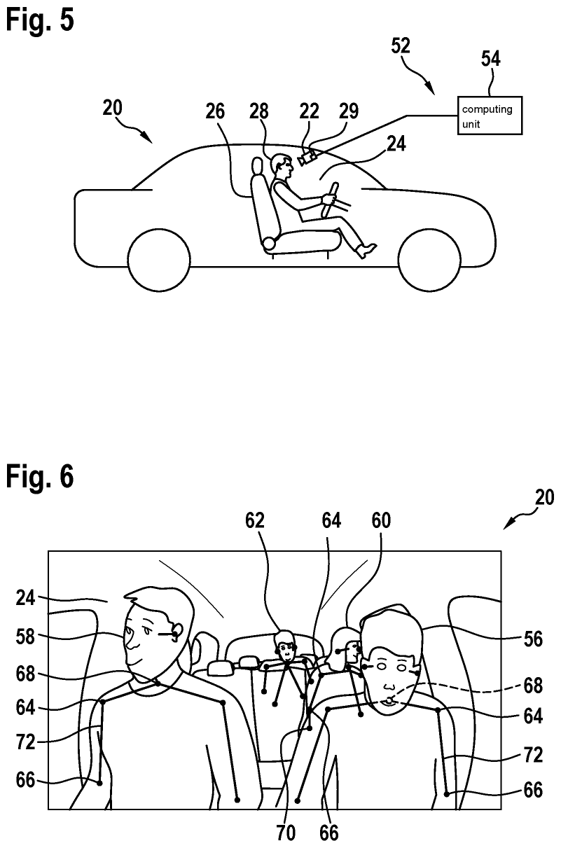

FIG. 2 shows a schematic representation of a method 30 for identifying a seat occupancy in a vehicle according to an exemplary embodiment of the present invention. The method 30 can be performed by means of a system according to the system according to FIG. 5.

In a first step 32 of the method 30, monitoring data of a camera of a vehicle interior are received. The monitoring data can, for example, be recorded by a camera in the vehicle interior. The camera can, for example, be designed as an observation device or as an observation unit and can be arranged in the vehicle. The observation device can, for example, be designed according to the observation device according to FIG. 1.

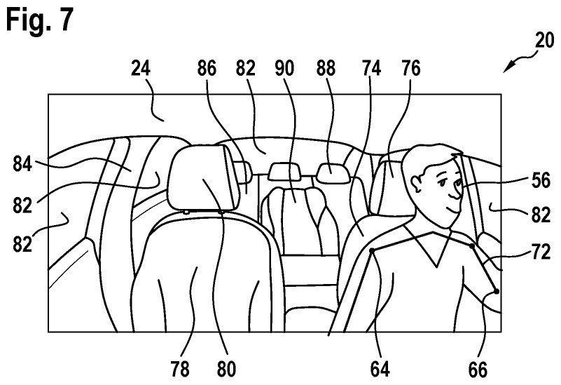

In a second step 34 of the method 30, pixels of the monitoring data are assigned to components of the vehicle by semantic segmentation by means of a first neural network. Preferably, the first neural network for semantic segmentation can be designed as a trained neural network. An application of semantic segmentation can, for example, be represented according to FIG. 7.

In one advantageous embodiment, a pixel-precise assignment of the monitoring data to components of the vehicle can take place per frame. In other words, each pixel in a frame can be assigned to a component of the vehicle. In this case, components may, for example, be a vehicle seat, a door, a window, a rear flap, a steering wheel, a pillar, or other elements in the vehicle. In a development, the pixels can be assigned to a vehicle seat pixel class, for recognizing which vehicle seat the pixels are assigned to. Advantageously, it can be recognized what vehicle seat it is, for example, a driver seat, a front passenger seat, or a seat of the rear bench, for example, the right seat of the rear bench, the left seat of the rear bench, or the center seat of the rear bench. The same applies to all further rear benches, provided they are located in the viewing range of step 32.

In other words, a semantic segmentation can be performed by means of the first network. In particular, a pixel-precise classification in the image can thereby take place.

In a development, the ascertained segmentation areas or recognized area of the semantic segmentation can be aggregated to a static mask in a further step. In other words, a mask can be created by means of the recognized components or areas of the vehicle interior. In particular, all non-static elements, such as persons and objects, are ignored and only static elements are aggregated over time. This process creates a static interior mask. This step can be performed once at a previously defined time and/or when no non-static elements, for example a person, are located in the vehicle. The further step can advantageously be carried out after or before the second step 34.

Advantageously, it can be ascertained which vehicle parts are located in front of a person, for example a front seat for a person who is sitting in the rear bench or in the second row. Furthermore, for example, a door pixel can be recognized or assigned. If it is ascertained that the door pixel is arranged in front of a recognized person, it can be deduced that the person is located outside the vehicle. Advantageously, a seat pixel can be recognized. In particular, a seat pixel occluded by a person pixel can indicate that the seat is behind the recognized person. A seat pixel class can also be ascertained, wherein the seat pixel class can be used to ascertain the type of the vehicle seat or which type the vehicle seat is. For example, it may be a driver seat, a front passenger seat, a right, left, or center seat of the rear bench.

In a third step 36 of the method 30, one or more persons in the monitoring data are recognized by means of a second neural network for recognizing a pose of a person. Preferably, the second neural network for recognizing a pose of a person can be designed as a trained neural network. The third step 36 can advantageously be carried out after, before, or in parallel with the second step 34. A recognition of a person or of a pose of a person can, for example, be represented according to FIG. 6.

In a development, a two-dimensional pose of a person or a three- dimensional pose of a person can be recognized. For this purpose, the monitoring data can, for example, be designed as two-dimensional monitoring data or as three-dimensional monitoring data, which are recorded or supplied by a two-dimensional monitoring unit or a three-dimensional monitoring unit.

In one advantageous embodiment, a size of the one or more persons can be recognized. As a result, it can in particular be recognized whether a person is located in the front area of the vehicle, i.e., in the front seats, or in the rear bench. If the size of an adult person is smaller than that of another adult person in the vehicle, it can be assumed that the person who was recognized as being smaller is sitting further toward the rear. Advantageously, articulation points of the one or more persons can also be recognized. For example, an elbow joint, a shoulder joint, a wrist, a neck, or other joints can be formed or recognized as articulation points. A recognition of articulation points of persons can, for example, be represented according to FIG. 6.

In other words, a pose of a person can be ascertained by means of the second network. As a result, a 2D position of the person in the image and/or a 3D pose can be ascertained. Advantageously, an approximate size of the person in the image can be ascertained, whereby it can in particular be recognized to which seat row a person can be assigned. If it is recognized that a person is very small in comparison to others and, for example, is largely arranged inside a window, it can be deduced that the person is outside the car.

In a fourth step 38 of the method 30, the recognized one or more persons are merged with the pixels assigned to the components of the vehicle, for identifying a seat occupancy in the vehicle. A merging can, for example, be represented according to FIG. 7.

In other words, the ratio of the recognized person(s) to the components of the vehicle and/or the arrangement in which the recognized person(s) are arranged relative to the components of the vehicle is recognized. As a result, it can be recognized where the recognized person(s) are arranged in front of, on, or behind the components of the vehicle. It can thereby be ascertained whether the recognized person(s) are arranged behind a vehicle seat, in front of a vehicle seat, or behind a vehicle door. In other words, it can be recognized whether the recognized person(s) are sitting in the vehicle seat and which vehicle seat it is.

One possibility of assigning a seat to a person is to calculate the common interface between the surface resulting from the parts of the pose, in particular without taking into account head support points, and the surface of the seat. In a development, the assignment of surfaces to surfaces or of points to surfaces can take place by means of a mathematical method.

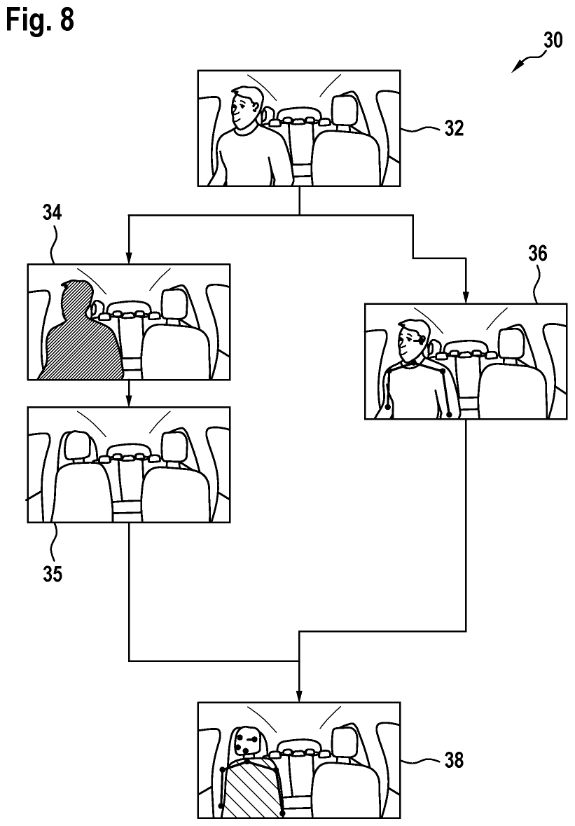

This can, for example, be represented by means of the method according to FIG. 8.

In a development, the merging can advantageously take place by means of a neural network, in particular a further neural network.

In one exemplary embodiment, pixels can in particular be assigned to one or more components of the vehicle which are arranged in front of a person, wherein, in the step of merging, it is recognized that the person is arranged behind the one or more components of the vehicle. For example, it can be recognized that a vehicle seat is arranged in front of a person. As a result, it can be recognized that the person is located behind the vehicle seat. For example, the vehicle seat can be the driver seat, with a person being identified behind the driver seat. As a result, it can be recognized that the person is arranged or is sitting behind the driver seat.

In a further embodiment, pixels can, for example, be assigned to a vehicle seat which is arranged behind a person, wherein, in the step of merging, it is recognized that the vehicle seat is arranged behind the person and the person is arranged in the vehicle seat. In other words, it is recognized that the person is sitting in the vehicle seat.

In a further embodiment, pixels which are arranged in front of a person can, for example, be assigned to a door of the vehicle, wherein, in the step of merging, it is recognized that the person is arranged behind the door outside the vehicle. Alternatively or additionally, pixels can, for example, be assigned to a window of the vehicle, wherein it is recognized that the person is arranged inside the window, in particular only inside the window. As a result, it can be recognized that the person is located outside the vehicle and thus not inside the vehicle.

In other words, the method is based on an output of two networks. The first network can be designed as semantic segmentation or object recognition. The second network can be designed as a person detector and/or as a person pose detector and/or as a 3D person pose detector.

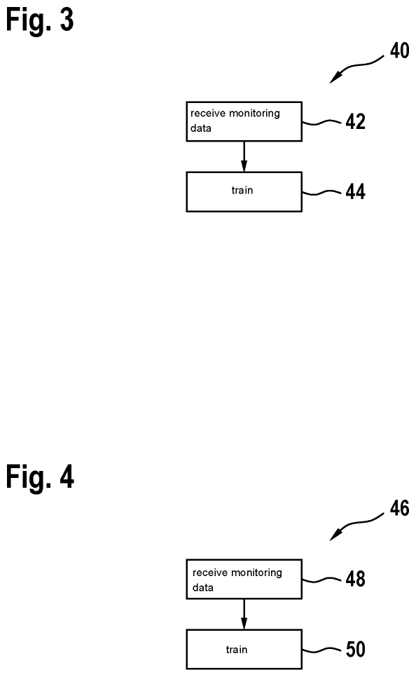

Advantageously, the two networks can be trained. The first neural network can, for example, be trained according to the method according to FIG. 3. The second neural network can, for example, be trained according to the method according to FIG. 4. The semantic segmentation learns, in particular for each pixel in the image, whether it is, for example, a window, a left seat in the second seat row, a backrest, a person, or other components or areas. Alternatively or additionally, an object detection can be learned for these classes. The second network learns a person pose. The semantic segmentation also has person pixels. However, by means of a person pose, pixels of overlapping persons can advantageously be distinguished from one another. In other words, by means of the recognition of a pose of a person, it can be recognized when two persons are arranged one behind the other or one in front of the other, and thus overlapping. By means of recognition of a person pose, the individual articulation points of the person can advantageously be detected, whereby distances and position of the articulation points can in particular be ascertained as far as possible independently of a possible occlusion and/or body posture. An example for the recognition of articulation points can be designed to be incremental according to FIG. 6. As a result, persons in space, in particular in the vehicle interior, can advantageously be better located. In a development, the second network can be designed as a 3D pose detector. In this case, an assignment of the articulation positions in space can take place absolutely or relative to the person center. Alternatively or additionally, an object detection can be used for persons.

A seat assignment can advantageously be ascertained by means of a combination of the two networks. By means of the pixel-precise semantic segmentation, it can be ascertained whether a person is located behind a seat or sits in the seat. It can also be ascertained whether a detected person is located inside or outside the vehicle. Through the semantic segmentation, the window pixel information can, for example, be used to determine whether a pose is in the window area. This can also be supported by deliberately learning visible person pixels outside the vehicle as window pixels. As a result, in addition to geometric derivation, the pixel class can also be used to determine whether a person is located inside or outside the vehicle.

In other words, by means of the described method, an output of two neural networks can be combined in order to make a seat assignment possible for any vehicle. For this purpose, the first neural network can be used to ascertain which pixels belong to which vehicle areas, for example window, left rear seat, front right head rest, and others. By means of the second neural network, a person pose can be ascertained. In combination, it can in particular be ascertained, for any vehicle and/or any camera mounting position, in which seat a recognized person or a plurality of recognized persons is located. As a result, it can additionally be ascertained how many persons are located in the vehicle. In other words, the number of persons in the vehicle can be ascertained. The method can advantageously carry out a seat assignment, in particular without calibration, for any vehicle type and/or camera mounting position.

The method can be used in any vehicle in which a number of persons and also a seat assignment are to be ascertained and can thus be useful. The method can, for example, comprise a further step for a seatbelt warning. In other words, a recognized person can be warned if they are unbelted. In a development, statistics on seat occupancies in transportation services can be collected. Furthermore, it can be recognized when a person moves away from a seat during a trip. To some components or devices in the car, it is also relevant whether a person is located in the driver seat and the car thus has a driver or not. This can be both safety-relevant and interesting for statistical reasons.

Advantageously, the monitoring data recorded by a camera can be monitoring data of a vehicle interior. The camera can be arranged in the vehicle interior for this purpose. Advantageously, the camera can be a camera fixedly installed in the vehicle. Alternatively or additionally, the camera can subsequently be arranged in the vehicle, for example as a retrofittable dash cam.

In other words, through the combination of the two networks in the method, a seat assignment can be carried out or ascertained for any vehicle class and/or camera mounting position.

FIG. 3 shows a schematic representation of a method 40 for training a first neural network to assign pixels of the monitoring data to components of the vehicle by semantic segmentation for use in a method for identifying a seat occupancy in a vehicle according to an exemplary embodiment of the present invention. The method for identifying a seat occupancy in a vehicle can, for example, be designed according to the method according to FIG. 2.

In a first step 42 of the method 40, monitoring data of a camera of a vehicle interior are received.

In a second step 44 of the method 40, for each pixel in a frame, it is learned to which component of the vehicle the pixel is assigned.

FIG. 4 shows a schematic representation of a method 46 for training a second neural network to recognize a pose of a person for use in a method for identifying a seat occupancy in a vehicle according to an exemplary embodiment of the present invention. The method for identifying a seat occupancy in a vehicle can, for example, be designed according to the method according to FIG. 2.

In a first step 48 of the method 46, monitoring data of a camera are received.

In a second step 50 of the method 46, poses of a plurality of persons are learned.

FIG. 5 shows a schematic representation of a system 52 for identifying a seat occupancy in a vehicle according to an exemplary embodiment of the present invention. The system 52 is designed to perform a method for identifying a seat occupancy in a vehicle 20 according to FIG. 2. The vehicle can be designed according to the vehicle 20 according to FIG. 1.

For performing the method, the system 52 can comprise a computing unit 54. The computing unit 54 can be arranged outside the vehicle 20 or inside the vehicle 20. In this advantageous embodiment, the system 52 also comprises a camera 22. The camera 22 can, for example, be designed as an observation device 22. The observation device 22 or the camera 22 can be designed according to FIG. 1 and/or be arranged in the vehicle 20.

FIG. 6 shows a schematic representation of a vehicle interior 24 according to an exemplary embodiment of the present invention. The vehicle interior 24 can, for example, be arranged in a vehicle according to the vehicle according to FIG. 1 and/or FIG. 5. FIG. 6 shows a representation of a pose output of recognized persons in the vehicle interior 24. The recognition of the pose can, for example, be carried out according to the method according to FIG. 2. In this advantageous embodiment, a first person 56 arranged in the driver seat, a second person 58 sitting in the front passenger seat, a third person 60 arranged in the second row behind the driver seat, and a fourth person 62 arranged in the right seat in the third row, thus in particular two seats behind the person in the driver seat, are recognized. Advantageously, for each of the persons, the articulation points can be represented as points and/or the limbs can be represented as lines. Advantageously, two shoulder joints 64, two elbow joints 66, one neck 68, and in particular a wrist 70 can be recognized for each recognized person. A straight line may, for example, also represent the upper arm 72 of a person. As a result, it can be ascertained that the persons are sitting in the seats. Furthermore, it can be ascertained that four persons are located in the vehicle 20 according to FIG. 6.

FIG. 7 shows a schematic representation of a vehicle interior 24 according to an exemplary embodiment of the present invention. The vehicle interior 24 can, for example, be arranged in a vehicle according to the vehicle according to FIG. 1 and/or FIG. 5. FIG. 7 shows a representation of semantic segmentation and a pose output of recognized persons in the vehicle interior 24. Components in the vehicle interior 24 can be recognized by semantic segmentation. Advantageously, the pixels of the representation according to FIG. 7 can be assigned to the components of the vehicle interior 24. Alternatively or additionally, in one advantageous embodiment, the vehicle interior 24 can be divided into different areas. Preferably, the components or areas can be represented or highlighted in different colors or shadings. In this advantageous embodiment, pixels are assigned to a backrest 74 of the driver seat, a head rest 76 of the driver seat, and a backrest 78 of the front passenger seat, and a head rest 80 of the front passenger seat. Pixels may also be assigned to one or more windows 82. Furthermore, pixels may be assigned to one or more vehicle pillars 84. Pixels may also be assigned to the seats 86 of the rear bench and the head rests 88 of the seats of the rear bench. In this advantageous embodiment, pixels may, in particular, also be assigned to a child seat 90 on the rear bench.

In this advantageous embodiment, a first person 56 arranged or sitting in the driver seat is furthermore recognized. Furthermore, a pose of the person 56 is recognized. The recognition of the person 56 and the pose of the person 56 can, for example, be ascertained by means of the method according to FIG. 2. A representation of a recognition of a pose of the person 56 can, for example, be represented according to FIG. 6. Advantageously, for the person 56 in the driver seat, the articulation points can be represented as points and/or the limbs can be represented as lines. Advantageously, shoulder joints 64, elbow joints 66, and others can be recognized. A straight line may, for example, also represent the upper arm 72 of the person. As a result, it can be ascertained that the person is sitting in the seat, in particular the driver seat. Furthermore, it can be ascertained that a person is located in the vehicle 20 according to FIG. 7.

FIG. 8 shows a schematic representation of a method 30 for identifying a seat occupancy in a vehicle according to an exemplary embodiment of the present invention. The method 30 can be performed by means of a system according to the system according to FIG. 5. The method 30 is designed according to the method 30 according to FIG. 2. The method 30 according to FIG. 8 thus comprises the first step 32, the second step 34, the third step 36, and the fourth step 38. According to FIG. 8, representations or images of the vehicle interior are, for example, represented according to the processing in the respective steps.

Advantageously, it is represented that the vehicle interior is recorded in the first step 32. In other words, monitoring data of the vehicle interior are recorded. Thus, in the first step, the vehicle interior is represented. Advantageously, each image can have a defined number of pixels.

In the second step 34, the monitoring data are processed in such a way that pixels of the monitoring data are assigned to components of the vehicle by semantic segmentation by means of a first neural network. Thus, in the second step, the components of the vehicle interior are categorized and represented. In an advantageous embodiment, moving objects, for example persons, are grayed out or blackened and thus not considered in this step. The assignment of the components can be designed according to FIG. 7.

In a development, the ascertained segmentation areas or recognized area of the semantic segmentation can be aggregated to a static mask in a further step 35. In other words, a mask of the vehicle interior with the different components and/or areas is created. In this case, moving objects are in particular not considered.

In the third step 36 of the method 30, one or more persons in the monitoring data are recognized by means of a second neural network for recognizing a pose of a person. A recognition of a person or of a pose of a person can, for example, be represented according to FIG. 6. In particular, articulation points of the person can be recognized, which thus allow a pose of the person to be deduced. In the third step 36, the vehicle interior with the person and the recognized articulation points is thus represented.

In a fourth step 38 of the method 30, the recognized one or more persons are merged with the pixels assigned to the components of the vehicle, for identifying a seat occupancy in the vehicle. In other words, the results of the second step 34 and of the third step 36 can be merged. This results in a representation of the vehicle interior divided into components and in a schematically represented person located therein, wherein articulation points of the person and thus a recognized pose are represented. As a result, it can be recognized in which seat the person is sitting. A merging for identifying a seat occupancy in the vehicle can, for example, be represented according to FIG. 6.

What is claimed is:

1. A method for identifying a seat occupancy in a vehicle, comprising the following steps:
receiving monitoring data of a camera of a vehicle interior;
assigning pixels of the monitoring data to components of the vehicle by semantic segmentation using a first neural network;
recognizing one or more persons in the monitoring data using a second neural network for recognizing a pose of a person; and
merging the assigned pixels to the components of the vehicle with the recognized one or more persons, for identifying a seat occupancy in the vehicle.

2. The method according to claim 1, wherein, in the step of recognizing the one or more persons in the monitoring data, a two-dimensional pose of a person or a three-dimensional pose of the person is recognized.

3. The method according to claim 1, wherein, in the step of recognizing one or more persons in the monitoring data, a size of the one or more persons is recognized.

4. The method according to claim 1, wherein, in the step of recognizing one or more persons in the monitoring data, articulation points of the one or more persons are recognized.

5. The method according to claim 1, wherein the first neural network for semantic segmentation is a trained neural network.

6. The method according to claim 1, wherein the second neural network for recognizing a pose of a person is a trained neural network.

7. The method according to claim 1, wherein, in the step of assigning pixels, a pixel-precise assignment of the monitoring data to components of the vehicle takes place per frame.

8. The method according to claim 1, wherein, in the step of assigning pixels, pixels are assigned to one or more components of the vehicle which are arranged in front of a person, wherein, in the step of merging, it is recognized that the person is arranged behind the one or more components of the vehicle.

9. The method according to claim 1, wherein, in the step of assigning pixels, pixels are assigned to a door of the vehicle which is arranged in front of a person, wherein, in the step of merging, it is recognized that the person is arranged behind the door outside the vehicle.

10. The method according to claim 1, wherein, in the step of assigning pixels, pixels are assigned to a vehicle seat which is arranged behind a person, wherein, in the step of merging, it is recognized that the vehicle seat is arranged behind the person and the person is arranged in the vehicle seat.

11. The method according to claim 1, wherein, in the step of assigning pixels, the pixels can be assigned to a vehicle seat pixel class, for recognizing which vehicle seat the pixels are assigned to.

12. A system for identifying a seat occupancy in a vehicle, wherein the system is configured to:
receive monitoring data of a camera of a vehicle interior;
assign pixels of the monitoring data to components of the vehicle by semantic segmentation using a first neural network;
recognize one or more persons in the monitoring data using a second neural network for recognizing a pose of a person; and
merge the assigned pixels to the components of the vehicle with the recognized one or more persons, for identifying a seat occupancy in the vehicle.

13. The system according to claim 12, comprising:
a camera configured to record the monitoring data of the vehicle interior.

14. A method for training a first neural network to assign pixels of monitoring data to components of the vehicle by semantic segmentation for use in a method for identifying a seat occupancy in a vehicle, the method for training comprising the following steps:
receiving monitoring data of a camera of a vehicle interior; and
learning, for each pixel in a frame, to which component of the vehicle the pixel is assigned.

15. A method for training a second neural network to recognize a pose of a person for use in a method for identifying a seat occupancy in a vehicle, the method comprising the following steps:
receiving monitoring data of a camera; and
learning poses of a plurality of persons.
